(19) United States
(12) Patent Application Publication
(10) Pub. No.: US 2015/0103411 A1
(43) Pub. Date: Apr. 16, 2015

(54) EYEPIECE OPTICAL SYSTEM AND ELECTRONIC APPARATUS

(71) Applicant: Sony Corporation, Tokyo (JP)

(72) Inventor: Kenta Katagata, Tokyo (JP)

(21) Appl. No.: 14/465,170

(22) Filed: Aug. 21, 2014

(30) Foreign Application Priority Data
Oct. 11, 2013 (JP) 2013-213370

(51) Int. Cl. G02B 25/00

(52) U.S. Cl. CPC G02B 25/001
USPC 359/644

(57) ABSTRACT

An eyepiece optical system includes: a first lens having a biconvex shape in optical axis center and having positive refractive power; a second lens having negative refractive power; a third lens having positive refractive power; and a fourth lens having positive refractive power. The first to fourth lenses are arranged in order from an image to be observed. The following conditional expression is satisfied,

0.47<f3/f4<3.00 (1)

where f3 is a focal length of the third lens, and f4 is a focal length of the fourth lens.

### CROSS REFERENCE TO RELATED APPLICATIONS

This application claims the benefit of Japanese Priority Patent Application JP 2013-213370 filed Oct. 11, 2013, the entire contents of each which are incorporated herein by reference.

### BACKGROUND

The present disclosure relates to an eyepiece optical system for observing an image (for example, an image displayed on an image display device) in an enlarged manner, and to an electronic apparatus that includes such an eyepiece optical system.

As an apparatus for observing, with the use of an eyepiece optical system, an image displayed on an image display device in an enlarged manner, there are an electronic viewfinder (EVF) in a camera, an electronic binocular, a head-mounted display, etc.

### SUMMARY

In an apparatus as described above, it is desired to increase magnification of a magnifying glass in an eyepiece optical system in order to reduce a size of an image display device while securing a sufficient viewing angle. In this case, it is desired that various aberrations are favorably corrected and desired visibility is secured even when the magnification of the magnifying glass in the eyepiece optical system is increased.

Japanese Unexamined Patent Application Publication No. 2010-266776 (JP 2010-266776A) discloses an eyepiece optical system having a three-lens configuration that includes a first lens having positive refractive power, a second lens having negative refractive power, and a third lens having positive refractive power in order from an image display device side.

Japanese Unexamined Patent Application Publication No. 2013-88632 (JP 2013-88632A) discloses an eyepiece optical system having a four-lens configuration that includes a first lens having positive refractive power, a second lens having negative refractive power, a third lens having positive refractive power, and a fourth lens having positive refractive power in order from an image display device side.

In both of the eyepiece optical systems described in JP 2010-266776A and JP 2013-88632A, the first lens has a meniscus shape that has a concave surface facing toward the image display device side. In both of the eyepiece optical systems described in JP 2010-266776A and JP 2013-88632A, magnification of a magnifying glass is as low as about nine to ten times magnification in order to retain favorable visibility. In particular, the third lens has a large diameter and a large thickness in the eyepiece optical system described in JP 2010-266776A, which is disadvantageous in reduction in size. Also, the eyepiece optical system described in JP 2010-266776A is disadvantageous in terms of manufacturing with the use of either glass or plastic because of its large volume. In the eyepiece optical system described in JP 2013-88632A, all of the lenses are configured of spherical lenses, the magnification of the magnifying glass is low, and aberration performance is not favorable. In particular, distortion is large.

It is desirable to provide an eyepiece optical system capable of securing desired visibility while increasing the magnification of the magnifying glass, and to provide an electronic apparatus provided with such an eyepiece optical system.

According to an embodiment of the present disclosure, there is provided an eyepiece optical system including: a first lens having a biconvex shape in optical axis center and having positive refractive power; a second lens having negative refractive power; a third lens having positive refractive power; and a fourth lens having positive refractive power, the first to fourth lenses being arranged in order from an image to be observed, in which the following conditional expression is satisfied,

0.47<f3/f4<3.00 (1)

where f3 is a focal length of the third lens, and f4 is a focal length of the fourth lens.

According to an embodiment of the present disclosure, there is provided an electronic apparatus including: an image display device; and an eyepiece optical system configured to allow observation, in an enlarged manner, of an image displayed on the image display device. The eyepiece optical system includes: a first lens having a biconvex shape in optical axis center and having positive refractive power; a second lens having negative refractive power; a third lens having positive refractive power; and a fourth lens having positive refractive power, the first to fourth lenses being arranged in order from an image to be observed, in which the following conditional expression is satisfied,

0.47<f3/f4<3.00 (1)

where f3 is a focal length of the third lens, and f4 is a focal length of the fourth lens.

In the eyepiece optical system and the electronic apparatus according to the above-described embodiments of the present disclosure, configurations of the first to fourth lenses are optimized in order to secure desired visibility while increasing the magnification of the magnifying glass.

According to the eyepiece optical system and the electronic apparatus according to the above-described embodiments of the present disclosure, the configurations of the first to fourth lenses are optimized, which makes it possible to secure desired visibility while increasing the magnification of the magnifying glass.

It is to be noted that effects of the present disclosure are not limited to those described here, and may include any effect described in the present disclosure.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a lens cross-sectional view illustrating a first configuration example of an eyepiece optical system according to an embodiment of the present disclosure.

FIG. 2 is a lens cross-sectional view illustrating a second configuration example of the eyepiece optical system.

FIG. 3 is a lens cross-sectional view illustrating a third configuration example of the eyepiece optical system.

FIG. 4 is a lens cross-sectional view illustrating a fourth configuration example of the eyepiece optical system.

FIG. 5 is a lens cross-sectional view illustrating a fifth configuration example of the eyepiece optical system.

FIG. 6 is an aberration diagram illustrating various aberrations in Numerical example 1 in which specific numerical values are applied to the eyepiece optical system illustrated in FIG. 1.

FIG. 7 is an aberration diagram illustrating various aberrations in Numerical example 2 in which specific numerical values are applied to the eyepiece optical system illustrated in FIG. 2.

FIG. 8 is an aberration diagram illustrating various aberrations in Numerical example 3 in which specific numerical values are applied to the eyepiece optical system illustrated in FIG. 3.

FIG. 9 is an aberration diagram illustrating various aberrations in Numerical example 4 in which specific numerical values are applied to the eyepiece optical system illustrated in FIG. 4.

FIG. 10 is an aberration diagram illustrating various aberrations in Numerical example 5 in which specific numerical values are applied to the eyepiece optical system illustrated in FIG. 5.

FIG. 11 is a front appearance diagram illustrating a configuration example of a camera as a first example of an electronic apparatus.

FIG. 12 is a rear appearance diagram illustrating the configuration example of the camera as the first example of the electronic apparatus.

FIG. 13 is an appearance diagram illustrating a configuration example of an electronic binocular as a second example of the electronic apparatus.

FIG. 14 is an appearance diagram illustrating a configuration example of a head-mounted display as a third example of the electronic apparatus.

### DETAILED DESCRIPTION

Some embodiments of the present disclosure are described below in detail with reference to the drawings. The description is provided in the following order.
1. Basic Configuration of Optical System
2. Functions and Effects
3. Application Examples to Electronic Apparatus
4. Numerical Examples of Optical System
5. Other Embodiments

### 1. Basic Configuration of Optical System

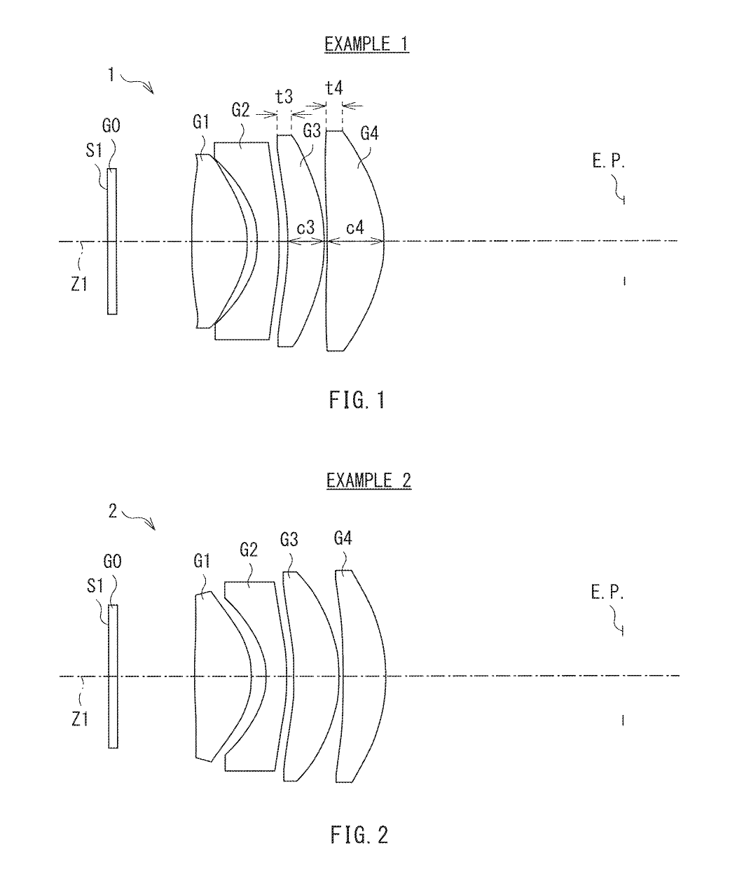

FIG. 1 illustrates a first configuration example of an eyepiece optical system according to an embodiment of the present disclosure. FIGS. 2 to 5 illustrate second to fifth configuration examples of the eyepiece optical system, respectively. Numerical examples in which specific numerical values are applied to the foregoing configuration examples are described later.

A configuration of the eyepiece optical system according to the present embodiment is described below in appropriate correspondence with the configuration examples illustrated in FIG. 1, etc.; however, the technology of the present disclosure is not limited to the illustrated configuration examples.

The eyepiece optical system according to the present embodiment is substantially configured of four lenses that are a first lens G1 having positive refractive power, a second lens G2 having negative refractive power, a third lens G3 having positive refractive power, and a fourth lens G4 having positive refractive power. The first lens G1, the second lens G2, the third lens G3, and the fourth lens G4 are arranged along an optical axis Z1 in order from an image to be observed. The first lens G1 has a biconvex shape in the optical axis center. Each of the first lens G1 to the fourth lens G4 may be desirably configured of an aspherical lens.

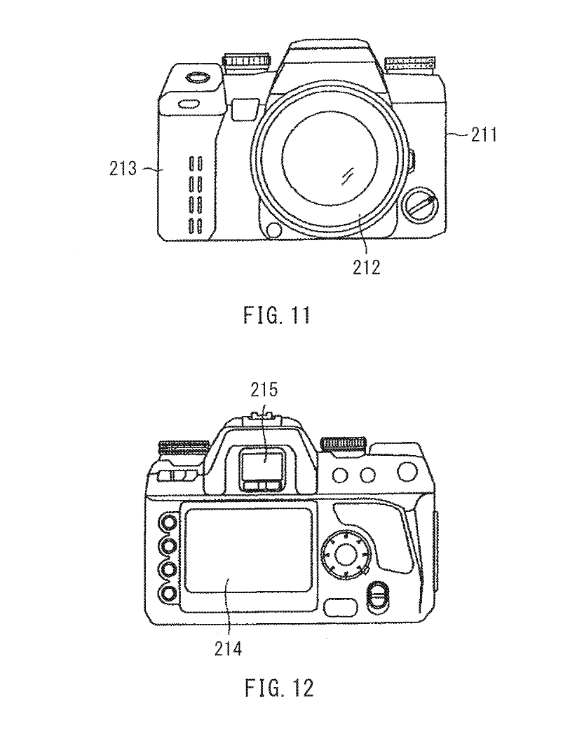

The eyepiece optical system according to the present embodiment may be applicable, for example, to an electronic viewfinder in an electronic apparatus such as a camera and an electronic binocular described later (FIGS. 11 to 13). Upon application to the electronic viewfinder, the eyepiece optical system is used for observing, in an enlarged manner, an image displayed on a display surface S1 of an image display device G0 such as an LCD (Liquid Crystal Display) or an organic EL display, as illustrated in FIG. 1, etc. An optical member such as a cover glass may be disposed between the image display device G0 and the first lens G1, which is not illustrated. Also, an optical member such as a cover glass may be disposed between the fourth lens G4 and an exit pupil (an eye point E.P.) of the eyepiece optical system.

Other than above, the eyepiece optical system according to the present embodiment may desirably satisfy predetermined conditional expressions, etc. described later.

### 2. Functions and Effects

Next, description is provided of functions and effects of the eyepiece optical system according to the present embodiment. Together therewith, description is provided of desirable configurations of the eyepiece optical system according to the present embodiment.

It is to be noted that the effects described herein are non-limited examples and other effects may be achieved.

According to the eyepiece optical system of the present embodiment, a four-lens configuration is substantially adopted and a configuration of each of the lenses is optimized. This makes it possible to achieve a finder having high visibility while having high magnification. Achievement of high magnification in the eyepiece optical system leads to achievement of a desired viewing angle with the use of the image display device G0 smaller than an existing image display device, which may contribute to reduction in size and in cost.

The eyepiece optical system according to the present embodiment desirably satisfies Conditional expression (1) below,

0.47<f3/f4<3.00 (1)

where f3 is a focal length of the third lens G3, and f4 is a focal length of the fourth lens G4.

Conditional expression (1) specifies favorable power distribution between the third lens G3 and the fourth lens G4. It is advantageous in correcting various aberrations that both of the third lens G3 and the fourth lens G4 are configured of lenses having positive power and imbalance is not caused in the power distribution therebetween. The various aberrations herein may refer to coma aberration, astigmatism, distortion, etc. Moreover, absence of imbalance in the power distribution between the third lens G3 and the fourth lens G4 prevents a thickness of either of the lenses from increasing excessively. This reduces volume per one lens. By causing a value of f3/f4 not to be smaller than 0.47 which is a lower limit in Conditional expression (1), the third lens G3 is prevented from having excessively-large power, which is advantageous in correcting various aberrations and in securing a sufficient viewing angle. By causing the value of f3/f4 not to be larger than 3.00 which is an upper limit in Conditional expression (1), the fourth lens G4 is prevented from having excessively-large power, which is advantageous in correcting various aberrations and in reducing total length of the eyepiece optical system.

Moreover, the eyepiece optical system according to the present embodiment may desirably satisfy Conditional expression (2) below,

12.0<250/ft<20.0 (2)

where ft is a total focal length of the eyepiece optical system.

Conditional expression (2) specifies magnification of a magnifying glass of a finder optical system. By causing a value of 250/ft not to be lower than 12.0 which is a lower limit in Conditional expression (2), it is possible to achieve a finder having a large viewing angle. By allowing the value of 250/ft not to be larger than 20.0 which is an upper limit in Conditional expression (2), it is possible to prevent variation in aberration resulting from excessively-large magnification of the magnifying glass and to prevent the size in a lens diameter direction from increasing. Also, it is possible to prevent foreign substances such as dust, defects, and white spots on the display surface from excessively attracting attention due to excessive increase in magnification. In particular, in a case of the electronic viewfinder, it is possible to prevent degradation in feeling of resolution upon use resulting from excessive enlargement of pixels in the image display device G0.

Moreover, the eyepiece optical system according to the present embodiment may desirably satisfy Conditional expression (3) below,

1.5<t3/c3<4.0 (3)

where t3 is a center thickness of the third lens G3 (see FIG. 1), and c3 is an edge thickness of the third lens G3 (see FIG. 1).

Moreover, the eyepiece optical system according to the present embodiment may desirably satisfy Conditional expression (4) below,

1.5<t4/c4<3.0 (4)

where t4 is a center thickness of the fourth lens G4 (see FIG. 1), and c4 is an edge thickness of the fourth lens G4 (see FIG. 1).

Conditional expression (3) specifies a preferable shape of the third lens G3. Conditional expression (4) specifies a preferable shape of the fourth lens G4. A ratio of a center thickness and an edge thickness is generally called a thickness deviation ratio. A value, of the thickness deviation ratio, closer to 1 allows a shape of a lens to be easier to be manufactured, which is advantageous in terms of formability. Being advantageous in formability means that tolerance from a design value in manufacturing is suppressed, which makes it possible to secure desired visibility more easily. By causing Conditional expressions (3) and (4) to be satisfied, the thickness deviation ratios related to the third lens G3 and the fourth lens G4 are improved, which decreases difficulty in forming the lenses. This achieves manufacturing with higher accuracy and smaller variations.

By causing a value of t3/c3 not to be lower than 1.50 which is a lower limit in Conditional expression (3), the lens is prevented from having excessively-small power, which is advantageous in securing a sufficient viewing angle. By causing the value of t3/c3 not to be larger than 4.00 which is an upper value in Conditional expression (3), the thickness deviation ratio of the lens is prevented from being excessively large, which is advantageous in formability.

By causing a value of t4/c4 not to be smaller than 1.50 which is a lower limit in Conditional expression (4), the lens is prevented from having excessively-small power, which is advantageous in securing a sufficient viewing angle. By causing the value of t4/c4 not to be larger than 3.00 which is an upper limit in Conditional expression (4), the thickness deviation ratio of the lens is prevented from being excessively large, which is advantageous in formability.

Moreover, the eyepiece optical system according to the present embodiment may desirably satisfy Conditional expression (5) below,

5.0<d1/d2<10.0 (5)

where d1 is a distance from image plane to be observed (the display surface S1 of the image display device G0) to an image-sided lens surface (a lens surface on the image display device G0 side) of the first lens G1, and d2 is a distance from a lens surface on an opposite side of (on an eye point E.P. side of) the first lens G1 from the image plane side to an image-sided lens surface of the second lens G2.

Conditional expression (5) specifies preferable arrangement positions of the first lens G1 and the second lens G2. By causing Conditional expression (5) to be satisfied, the eyepiece optical system becomes advantageous in reducing total length thereof, in securing a sufficient viewing angle, and in correcting various aberrations, in particular, in correcting distortion.

### 3. Application Examples to Electronic Apparatus

FIGS. 11 and 12 illustrate a configuration example of a camera as a first example of an electronic apparatus to which the eyepiece optical system according to the present embodiment is applied. The camera may be, for example, a digital camera having an interchangeable lens. As illustrated in FIG. 11, the camera may include an interchangeable shooting lens unit (interchangeable lens) 212 on a right-front side of a camera body 211, and may include a grip section 213 on the left-front side thereof. The grip section 213 is provided for a photographer to grip. As illustrated in FIG. 12, a monitor 214 is provided around the middle of the rear face of the camera body 211. An electronic viewfinder 215 is provided above the monitor 214. The photographer is allowed to visually recognize an image of a subject introduced from the shooting lens unit 212 to determine composition by looking in the viewfinder 215. It is possible to provide the image display device G0 illustrated in FIG. 1, etc. in the viewfinder 215 and to apply the eyepiece optical system according to the present embodiment to the viewfinder 215. In this case, a shot image obtained by an imaging section including the shooting lens unit 212 is displayed on the image display device G0. The photographer is allowed to observe, in an enlarged manner, the shot image displayed on the image display device G0 with the use of the eyepiece optical system. It is to be noted that the eyepiece optical system according to the present embodiment is also applicable to a digital camera without an interchangeable lens.

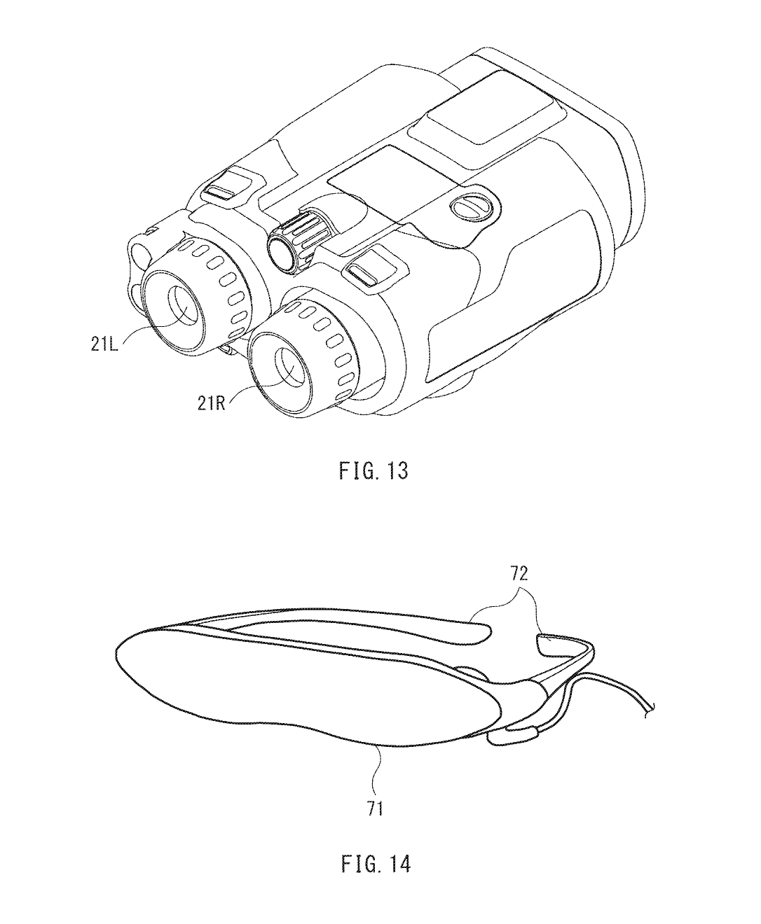

FIG. 13 illustrates a configuration example of an electronic binocular as a second example of the electronic apparatus to which the eyepiece optical system according to the present embodiment is applied. The electronic binocular may be used, for example, when an observer sees, with one's both eyes, a distant view, etc. in an enlarged manner. The electronic binocular may include a left-eye viewfinder 21L and a right-eye viewfinder 21R. It is possible to provide the image display device G0 illustrated in FIG. 1, etc. in each of the viewfinders 21L and 21R, and to apply the eyepiece optical system according to the present embodiment to the viewfinders 21L and 21R. In this case, an image obtained by a left-eye objective lens and a left-eye imaging device is displayed on the left-eye image display device G0. Also, an image obtained by a right-eye objective lens and a right-eye imaging device is displayed on the right-eye image display device G0. The observer is allowed to observe, in an enlarged manner, the image displayed on the left-eye image display device G0 by one's left eye with the use of the left-eye eyepiece optical system. Also, the observer is allowed to observe, in an enlarged manner, the image displayed on the right-eye image display device G0 by one's right eye with the use of the right-eye eyepiece optical system.

FIG. 14 illustrates a configuration example of a head-mounted display as a third example of the electronic apparatus to which the eyepiece optical system according to the present embodiment is applied. The head-mounted display may include, for example, ear hanging sections 72 on both sides of a display section 71 having an eye-glass shape. The ear hanging sections 72 are for mounting the head-mounted display on user's head. The display section 71 may be provided with a left-eye display section and a right-eye display section. The display section 71 is thus capable of providing images separately for the left eye and the right eye. It is possible to provide the image display device G0 illustrated in FIG. 1, etc. in each of the left-eye display section and the right-eye display section, and to apply the eyepiece optical system according to the present embodiment to the display sections for left and right eyes. In this case, a left-eye image display device G0 and a left-eye eyepiece optical system for enlarging an image displayed on the left-eye image display device G0 is provided in the left-eye display section. A right-eye image display device G0 and a right-eye eyepiece optical system for enlarging an image displayed on the right-eye image display device G0 is provided in the right-eye display section. The eyepiece optical system according to the present embodiment is applicable as the left-eye eyepiece optical system and as the right-eye eyepiece optical system.

It is to be noted that description is provided above referring to the examples of the camera, the electronic binocular, and the head-mounted display as the electronic apparatus to which the eyepiece optical system according to the present embodiment is applied. However, the eyepiece optical system according to the present embodiment is widely applicable to apparatuses other than the above-mentioned electronic apparatuses.

### EXAMPLES

### 4. Numerical Examples of Optical System

Next, description is provided of specific numerical examples of the eyepiece optical system according to the present embodiment. Description is provided below of numerical examples in which specific numerical values are applied to the eyepiece optical systems 1 to 5 in the respective configuration examples illustrated FIGS. 1 to 5.

Symbols etc. in tables and the description below represent the following. “Surface number” represents the number of an i-th surface counted from the image to be observed. “Curvature radius” represents a value (mm) of a paraxial curvature radius of the i-th surface. “Spacing” represents a value (mm) of a spacing on the optical axis between the i-th surface and the (i+1)th surface. Related to the spacing, a spacing that is variable in accordance with diopter adjustment is indicated as “Di”. “Refractive index” represents a value of a refractive index of the d-line (having a wavelength of 587.6 nm) of a material of an optical component having the i-th surface. “Abbe number” represents a value of an Abbe number, with respect to the d-line, of the material of the optical component having the i-th surface. “∞” indicated as the value of “curvature radius” indicates that the relevant surface is a planar surface or a virtual plane.

Some of the lenses used in the respective numerical examples have lens surfaces formed as aspherical surfaces. “ASP” in “surface number” indicates that the relevant surface is an aspherical surface. A shape of the aspherical surface is defined by the following expression of aspherical surface. It is to be noted that, in the respective tables showing aspherical surface coefficients described later, “E-i” represents an exponential expression having 10 as a base, i.e., “10⁻ⁱ”. To give an example, “0.12345E-05” represents “0.12345×10⁻⁵”.

### (Expression of Aspherical Surface)

x=cy²/[1+{1−(1+k)c²y²}^{1/2}]+A4y⁴+A6y⁶+A8y⁸+A10y¹⁰+A12y¹²

“x” is a distance from a point on the aspherical surface having a height of y from an optical axis to a tangent plane at a vertex of the aspherical surface, “y” is the height from the optical axis, “c” is a paraxial curvature (a reciprocal of curvature radius), “k” is a conic constant, and “An” is n-th order aspherical coefficient.

### Configuration Common to Respective Numerical Examples

Each of the eyepiece optical systems 1 to 5 to which the respective numerical examples below are applied is substantially configured of four lenses that are the first lens G1, the second lens G2, the third lens G3, and the fourth lens G4, and has a configuration that satisfies the basic configuration and the respective conditional expressions described above.

Diopter adjustment is performed through causing the first lens G1 to the fourth lens G4 as a whole to travel together along the optical axis Z1.

### Numerical Example 1

In an eyepiece optical system 1 illustrated in FIG. 1, the first lens G1 has a biconvex shape in the optical axis center. Each of the second lens G2, the third lens G3, and the fourth lens G4 has, in the optical axis center, a meniscus shape that has a concave surface facing toward the image to be observed and has a convex surface facing toward the eye point E.P.

Table 1 shows lens data of Numerical example 1 to which specific numerical values are applied to the eyepiece optical system 1. Table 2 shows values of variable spacings upon diopter adjustment where diopters are −4 diopter, −1 diopter, and +3 diopter. It is to be noted that FIG. 1 illustrates the lens arrangement where diopter is −1 diopter. Further, in Table 1, the 11th surface is a virtual surface, and the eye point E.P. is located at a position 18.00 mm away from the 11th surface.

In Numerical example 1, each of the lens surfaces (the 3rd surface to the 10th surface) of the first lens G1 to the fourth lens G4 is aspherical. Table 3 shows values of n-th order aspherical coefficients An of those aspherical surfaces, together with values of conic constant k.

TABLE 1
Example 1

| | Surface | Curvature | | Refractive | Abbe |
|---|---|---|---|---|---|
| Lens | number | radius | Spacing | index | number |
| (G0) | 1 | ∞ | 0.70 | 1.517 | 64.1 |
| | 2 | ∞ | D2(Variable) | | |
| G1 | 3(ASP) | 57.66 | 4.62 | 1.531 | 56.0 |
| | 4(ASP) | −7.51 | 0.84 | | |
| G2 | 5(ASP) | −7.86 | 1.80 | 1.638 | 23.4 |
| | 6(ASP) | −25.80 | 0.74 | | |
| G3 | 7(ASP) | −28.74 | 2.91 | 1.531 | 56.0 |
| | 8(ASP) | −17.56 | 0.30 | | |
| G4 | 9(ASP) | −41.23 | 4.77 | 1.531 | 56.0 |
| | 10(ASP) | −11.29 | D10(Variable) | | |
| (Virtual | 11 | ∞ | 18.00 | | |
| surface) | | | | | |

TABLE 2
Example 1

| diopter | −4 | −1 | 3 |
|---|---|---|---|
| D2 | 5.49 | 6.40 | 7.51 |
| D10 | 2.32 | 1.40 | 0.30 |

TABLE 3
Example 1

| Surface | | | | | |
|---|---|---|---|---|---|
| number | k | A4 | A6 | A8 | A10 |
| 3 | 0 | 2.164E−04 | −1.516E−05 | 3.420E−07 | −5.087E−11 |
| 4 | 0 | 6.828E−05 | 2.934E−05 | −1.015E−06 | 2.889E−08 |
| 5 | 0 | −6.226E−04 | 3.592E−05 | −4.768E−07 | −1.912E−09 |
| 6 | 0 | −4.380E−06 | 5.039E−06 | −6.385E−08 | −1.052E−10 |
| 7 | 0 | −3.881E−04 | 1.664E−05 | −1.941E−07 | 9.715E−10 |
| 8 | 0 | −5.554E−04 | 1.916E−05 | −2.173E−07 | −2.157E−10 |
| 9 | 0 | 2.434E−04 | −7.494E−07 | −1.019E−08 | 2.377E−11 |
| 10 | 0 | 2.695E−04 | −5.086E−06 | 8.870E−08 | −5.222E−10 |

| Surface | | | |
|---|---|---|---|
| number | k | A12 | A14 |
| 3 | 0 | −5.421E−11 | 0.000E+00 |
| 4 | 0 | −4.124E−10 | 2.519E−12 |
| 5 | 0 | 7.722E−11 | 1.816E−13 |
| 6 | 0 | 2.717E−12 | 2.187E−14 |
| 7 | 0 | −8.223E−12 | 6.284E−14 |
| 8 | 0 | 2.412E−11 | −1.504E−13 |
| 9 | 0 | 4.472E−13 | 0.000E+00 |
| 10 | 0 | −1.370E−12 | 2.220E−14 |

### Numerical Example 2

In an eyepiece optical system 2 illustrated in FIG. 2, the first lens G1 has a biconvex shape in the optical axis center. Each of the second lens G2, the third lens G3, and the fourth lens G4 has, in the optical axis center, a meniscus shape that has a concave surface facing toward the image to be observed and has a convex surface facing toward the eye point E.P.

Table 4 shows lens data of Numerical example 2 to which specific numerical values are applied to the eyepiece optical system 2. Table 5 shows values of variable spacings upon diopter adjustment where diopters are −4 diopter, −1 diopter, and +3 diopter. It is to be noted that FIG. 2 illustrates the lens arrangement where diopter is −1 diopter. Further, in Table 4, the 11th surface is a virtual surface, and the eye point E.P. is located at a position 18.00 mm away from the 11th surface.

In Numerical example 2, each of the lens surfaces (the 3rd surface to the 10th surface) of the first lens G1 to the fourth lens G4 is aspherical. Table 6 shows values of n-th order aspherical coefficients An of those aspherical surfaces, together with values of conic constant k.

TABLE 4
Example 2

| | Surface | Curvature | | Refractive | Abbe |
|---|---|---|---|---|---|
| Lens | number | radius | Spacing | index | number |
| (G0) | 1 | ∞ | 0.70 | 1.517 | 64.1 |
| | 2 | ∞ | D2(Variable) | | |
| G1 | 3(ASP) | 47.51 | 4.86 | 1.531 | 56.0 |
| | 4(ASP) | −7.93 | 1.35 | | |
| G2 | 5(ASP) | −7.38 | 1.80 | 1.638 | 23.4 |
| | 6(ASP) | −20.27 | 0.60 | | |
| G3 | 7(ASP) | −21.03 | 3.87 | 1.531 | 56.0 |
| | 8(ASP) | −12.93 | 0.36 | | |
| G4 | 9(ASP) | −44.54 | 3.70 | 1.531 | 56.0 |
| | 10(ASP) | −13.86 | D10(Variable) | | |
| (Virtual | 11 | ∞ | 18.00 | | |
| surface) | | | | | |

TABLE 5
Example 2

| diopter | −4 | −1 | 3 |
|---|---|---|---|
| D2 | 5.72 | 6.74 | 8.26 |
| D10 | 2.82 | 1.82 | 0.30 |

TABLE 6
Example 2

| Surface | | | | | |
|---|---|---|---|---|---|
| number | k | A4 | A6 | A8 | A10 |
| 3 | 0 | 3.326E−05 | −1.099E−05 | −8.585E−08 | 9.138E−09 |
| 4 | 0 | −4.688E−04 | 3.751E−05 | −9.356E−07 | 1.561E−08 |
| 5 | 0 | −1.202E−03 | 8.233E−05 | −1.607E−06 | 1.115E−08 |
| 6 | 0 | 8.834E−05 | −7.987E−07 | 1.173E−07 | −1.719E−09 |
| 7 | 0 | 2.222E−04 | −7.298E−06 | 2.742E−07 | −4.692E−09 |
| 8 | 0 | −1.491E−04 | 8.228E−06 | −1.441E−07 | 1.515E−10 |
| 9 | 0 | 2.915E−04 | −9.013E−06 | 8.301E−08 | 6.510E−11 |
| 10 | 0 | 2.140E−04 | −5.781E−06 | 6.881E−08 | −2.326E−10 |

| Surface | | | |
|---|---|---|---|
| number | k | A12 | A14 |
| 3 | 0 | −9.397E−11 | 0.000E+00 |
| 4 | 0 | −1.200E−10 | 5.740E−13 |
| 5 | 0 | 9.853E−11 | −1.023E−12 |
| 6 | 0 | 3.950E−12 | 2.139E−14 |
| 7 | 0 | 4.279E−11 | −1.921E−13 |
| 8 | 0 | 2.253E-11 | −1.783E−13 |
| 9 | 0 | −2.300E−12 | 0.000E+00 |
| 10 | 0 | −1.487E−12 | 1.683E−14 |

### Numerical Example 3

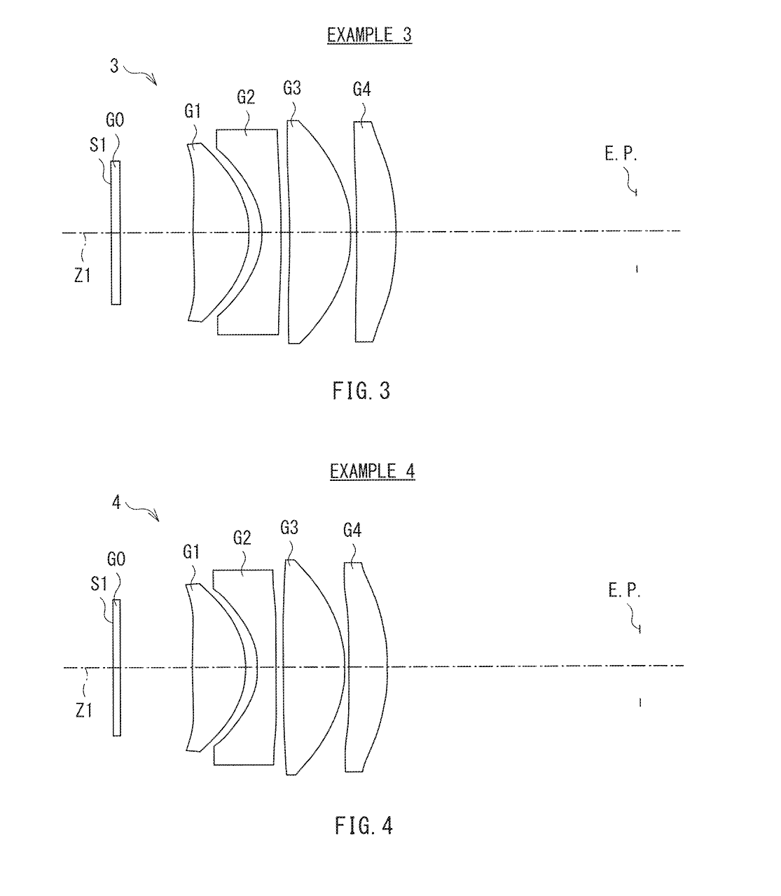

In an eyepiece optical system 3 illustrated in FIG. 3, the first lens G1 has a biconvex shape in the optical axis center. The second lens G2 has a biconcave shape in the optical axis center. Each of the third lens G3 and the fourth lens G4 has, in the optical axis center, a meniscus shape that has a concave surface facing toward the image to be observed and has a convex surface facing toward the eye point E.P.

Table 7 shows lens data of Numerical example 3 to which specific numerical values are applied to the eyepiece optical system 3. Table 8 shows values of variable spacings upon diopter adjustment where diopters are −4 diopter, −1 diopter, and +3 diopter. It is to be noted that FIG. 3 illustrates the lens arrangement where diopter is −1 diopter. Further, in Table 7, the 11th surface is a virtual surface, and the eye point E.P. is located at a position 18.00 mm away from the 11th surface.

In Numerical example 3, each of the lens surfaces (the 3rd surface to the 10th surface) of the first lens G1 to the fourth lens G4 is aspherical. Table 9 shows values of n-th order aspherical coefficients An of those aspherical surfaces, together with values of conic constant k.

TABLE 7
Example 3

| | Surface | Curvature | | Refractive | Abbe |
|---|---|---|---|---|---|
| Lens | number | radius | Spacing | index | number |
| (G0) | 1 | ∞ | 0.70 | 1.517 | 64.1 |
| | 2 | ∞ | D2(Variable) | | |
| G1 | 3(ASP) | 64.59 | 4.79 | 1.531 | 56.0 |
| | 4(ASP) | −8.06 | 1.08 | | |
| G2 | 5(ASP) | −7.81 | 1.60 | 1.614 | 26.0 |
| | 6(ASP) | 913.35 | 0.78 | | |
| G3 | 7(ASP) | −425.56 | 5.32 | 1.531 | 56.0 |
| | 8(ASP) | −11.65 | 0.40 | | |
| G4 | 9(ASP) | −544.49 | 3.42 | 1.531 | 56.0 |
| | 10(ASP) | −23.14 | D10(Variable) | | |
| (Virtual | 11 | ∞ | 18.00 | | |
| surface) | | | | | |

TABLE 8
Example 3

| diopter | −4 | −1 | 3 |
|---|---|---|---|
| D2 | 5.43 | 6.42 | 8.02 |
| D10 | 2.98 | 2.00 | 0.40 |

TABLE 9
Example 3

| Surface | | | | | |
|---|---|---|---|---|---|
| number | k | A4 | A6 | A8 | A10 |
| 3 | 0 | 9.707E−05 | −1.907E−05 | 2.129E−07 | 0.000E+00 |
| 4 | 0 | 7.889E−05 | −4.723E−07 | 5.214E−08 | 1.053E−09 |
| 5 | 0 | −4.155E−04 | 1.400E−05 | 8.129E−08 | −1.232E−09 |
| 6 | 0 | −2.102E−04 | 3.421E−06 | −1.563E−08 | 0.000E+00 |
| 7 | 0 | −5.460E−05 | 7.824E−07 | 2.351E−10 | 0.000E+00 |
| 8 | 0 | −5.363E−05 | 2.037E−06 | −6.283E−09 | −1.266E−11 |
| 9 | 0 | −3.777E−05 | −2.276E−07 | 5.422E−09 | 2.698E−11 |
| 10 | 0 | −3.532E−05 | 7.222E−08 | −6.170E−09 | 1.044E−10 |

| Surface | | | |
|---|---|---|---|
| number | k | A12 | A14 |
| 3 | 0 | 0.000E+00 | 0.000E+00 |
| 4 | 0 | 0.000E+00 | 0.000E+00 |
| 5 | 0 | 0.000E+00 | 0.000E+00 |
| 6 | 0 | 0.000E+00 | 0.000E+00 |
| 7 | 0 | 0.000E+00 | 0.000E+00 |
| 8 | 0 | 0.000E+00 | 0.000E+00 |
| 9 | 0 | 0.000E+00 | 0.000E+00 |
| 10 | 0 | 0.000E+00 | 0.000E+00 |

### Numerical Example 4

In an eyepiece optical system 4 illustrated in FIG. 4, the first lens G1 has a biconvex shape in the optical axis center. The second lens G2 has a biconcave shape in the optical axis center. The third lens G3 has a biconvex shape in the optical axis center. The fourth lens G4 has, in the optical axis center, a meniscus shape that has a concave surface facing toward the image to be observed and has a convex surface facing toward the eye point E.P.

Table 10 shows lens data of Numerical example 4 to which specific numerical values are applied to the eyepiece optical system 4. Table 11 shows values of variable spacings upon diopter adjustment where diopters are −4 diopter, −1 diopter, and +3 diopter. It is to be noted that FIG. 4 illustrates the lens arrangement where diopter is −1 diopter. Further, in Table 10, the 11th surface is a virtual surface, and the eye point E.P. is located at a position 18.00 mm away from the 11th surface.

In Numerical example 4, each of the lens surfaces (the 3rd surface to the 10th surface) of the first lens G1 to the fourth lens G4 is aspherical. Table 12 shows values of n-th order aspherical coefficients An of those aspherical surfaces, together with values of conic constant k.

TABLE 10
Example 4

| | Surface | Curvature | | Refractive | Abbe |
|---|---|---|---|---|---|
| Lens | number | radius | Spacing | index | number |
| (G0) | 1 | ∞ | 0.70 | 1.517 | 64.1 |
| | 2 | ∞ | D2(Variable) | | |
| G1 | 3(ASP) | 58.38 | 4.78 | 1.531 | 56.0 |
| | 4(ASP) | −8.31 | 1.13 | | |
| G2 | 5(ASP) | −7.96 | 1.60 | 1.614 | 26.0 |
| | 6(ASP) | 479.26 | 0.69 | | |
| G3 | 7(ASP) | 150.41 | 5.45 | 1.531 | 56.0 |
| | 8(ASP) | −12.13 | 0.40 | | |
| G4 | 9(ASP) | −93.68 | 3.32 | 1.531 | 56.0 |
| | 10(ASP) | −19.68 | D10(Variable) | | |
| (Virtual | 11 | ∞ | 18.00 | | |
| surface) | | | | | |

TABLE 11
Example 4

| diopter | −4 | −1 | 3 |
|---|---|---|---|
| D2 | 5.42 | 6.33 | 7.88 |
| D10 | 2.86 | 1.94 | 0.40 |

TABLE 12
Example 4

| Surface | | | | | |
|---|---|---|---|---|---|
| number | k | A4 | A6 | A8 | A10 |
| 3 | 0 | 6.308E−05 | −1.696E−05 | 1.834E−07 | 0.000E+00 |
| 4 | 0 | −1.296E−05 | 1.490E−06 | 2.256E−08 | 9.109E−10 |
| 5 | 0 | −4.720E−04 | 1.495E−05 | 3.467E−08 | −9.719E−10 |
| 6 | 0 | −2.018E−04 | 3.217E−06 | −1.746E−08 | 0.000E+00 |
| 7 | 0 | −6.668E−05 | 8.713E−07 | −1.638E−09 | −1.729E−11 |
| 8 | 0 | −7.209E−05 | 2.000E−06 | −5.442E−09 | −2.218E−11 |
| 9 | 0 | −3.990E−05 | −1.290E−07 | 6.659E−09 | 3.442E−11 |
| 10 | 0 | −1.248E−05 | 1.120E−07 | −7.263E−09 | 1.290E−10 |

| Surface | | | |
|---|---|---|---|
| number | k | A12 | A14 |
| 3 | 0 | 0.000E+00 | 0.000E+00 |
| 4 | 0 | 0.000E+00 | 0.000E+00 |
| 5 | 0 | 0.000E+00 | 0.000E+00 |
| 6 | 0 | 0.000E+00 | 0.000E+00 |
| 7 | 0 | 0.000E+00 | 0.000E+00 |
| 8 | 0 | 0.000E+00 | 0.000E+00 |
| 9 | 0 | 0.000E+00 | 0.000E+00 |
| 10 | 0 | 0.000E+00 | 0.000E+00 |

### Numerical Example 5

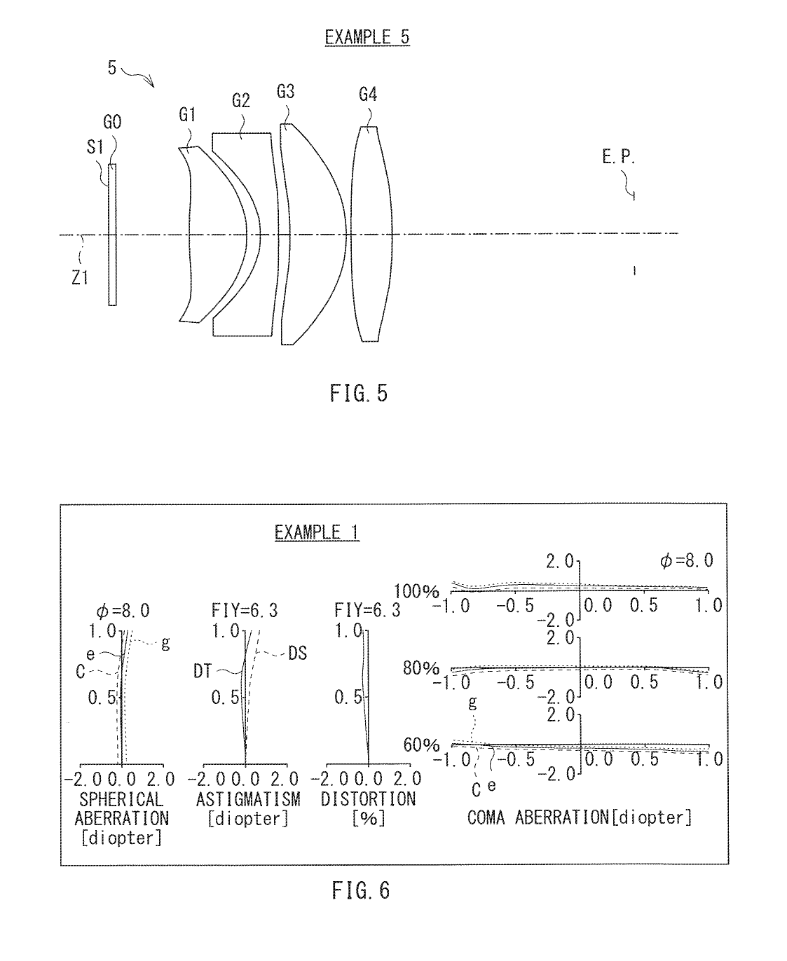

In an eyepiece optical system 5 illustrated in FIG. 5, the first lens G1 has a biconvex shape in the optical axis center. Each of the second lens G2 and the third lens G3 has, in the optical axis center, a meniscus shape that has a concave surface facing toward the image to be observed and has a convex surface facing toward the eye point E.P. The fourth lens G4 has a biconvex shape in the optical axis center.

Table 13 shows lens data of Numerical example 5 to which specific numerical values are applied to the eyepiece optical system 5. Table 14 shows values of variable spacings upon diopter adjustment where diopters are −4 diopter, −1 diopter, and +3 diopter. It is to be noted that FIG. 5 illustrates the lens arrangement where diopter is −1 diopter. Further, in Table 13, the 11th surface is a virtual surface, and the eye point E.P. is located at a position 18.00 mm away from the 11th surface.

In Numerical example 5, each of the lens surfaces (the 3rd surface to the 10th surface) of the first lens G1 to the fourth lens G4 is aspherical. Table 15 shows values of n-th order aspherical coefficients An of those aspherical surfaces, together with values of conic constant k.

TABLE 13
Example 5

| | Surface | Curvature | | Refractive | Abbe |
|---|---|---|---|---|---|
| Lens | number | radius | Spacing | index | number |
| (G0) | 1 | ∞ | 0.70 | 1.517 | 64.1 |
| | 2 | ∞ | D2(Variable) | | |
| G1 | 3(ASP) | 96.23 | 4.86 | 1.531 | 56.0 |
| | 4(ASP) | −8.26 | 1.21 | | |
| G2 | 5(ASP) | −7.97 | 1.60 | 1.614 | 26.0 |
| | 6(ASP) | −68.30 | 0.91 | | |
| G3 | 7(ASP) | −30.82 | 4.94 | 1.531 | 56.0 |
| | 8(ASP) | −11.19 | 0.40 | | |
| G4 | 9(ASP) | 68.06 | 3.59 | 1.531 | 56.0 |
| | 10(ASP) | −28.93 | D10(Variable) | | |
| (Virtual | 11 | ∞ | 18.00 | | |
| surface) | | | | | |

TABLE 14
Example 5

| diopter | −4 | −1 | 3 |
|---|---|---|---|
| D2 | 5.42 | 6.36 | 8.11 |
| D10 | 3.13 | 2.18 | 0.41 |

TABLE 15
Example 5

| Surface | | | | | |
|---|---|---|---|---|---|
| number | k | A4 | A6 | A8 | A10 |
| 3 | 0 | 3.861E−04 | −2.341E−05 | 2.277E−07 | −7.648E−10 |
| 4 | 0 | 1.542E−04 | −2.329E−06 | 4.818E−08 | 5.445E−12 |
| 5 | 0 | −5.579E−04 | 1.291E−05 | 4.900E−08 | −2.160E−10 |
| 6 | 0 | −1.817E−04 | 2.177E−06 | 5.641E−09 | −7.855E−11 |
| 7 | 0 | 4.169E−05 | 7.586E−07 | 7.548E−10 | −6.649E−12 |
| 8 | 0 | −4.199E−05 | 1.389E−06 | 5.175E−09 | −2.515E−11 |
| 9 | 0 | 1.898E−05 | −5.949E−07 | 2.364E−09 | 5.622E−11 |
| 10 | 0 | 1.345E−05 | −4.706E−09 | −3.341E−09 | 3.746E−12 |

| Surface | | | |
|---|---|---|---|
| number | k | A12 | A14 |
| 3 | 0 | 1.511E−12 | 0.000E+00 |
| 4 | 0 | 1.353E−11 | 0.000E+00 |
| 5 | 0 | 2.752E−12 | 0.000E+00 |
| 6 | 0 | 0.000E+00 | 0.000E+00 |
| 7 | 0 | 0.000E+00 | 0.000E+00 |
| 8 | 0 | −5.819E−14 | 0.000E+00 |
| 9 | 0 | 0.000E+00 | 0.000E+00 |
| 10 | 0 | 6.636E−13 | 0.000E+00 |

### Other Numerical Data of Respective Examples

Table 16 shows a summary of values related to the respective conditional expressions described above for the respective numerical examples. As can be seen from Table 16, the values in the respective numerical examples related to the respective conditional expressions are within the numerical ranges thereof.

TABLE 16

| Conditional expression | | | Example | | | | |
|---|---|---|---|---|---|---|---|
| | min | max | 1 | 2 | 3 | 4 | 5 |
| f3/f4 | 0.47 | 3.00 | 2.8 | 1.5 | 0.5 | 0.5 | 0.8 |
| 250/ft | 12.0 | 20.0 | 15.5 | 14.9 | 14.5 | 14.7 | 14.4 |
| t3/c3 | 1.5 | 4.0 | 1.7 | 2.0 | 2.9 | 3.6 | 3.3 |
| t4/c4 | 1.5 | 3.0 | 2.4 | 2.0 | 1.9 | 2.2 | 2.4 |
| d1/d2 | 5.0 | 10.0 | 8.5 | 5.5 | 6.6 | 6.2 | 5.9 |

### Aberration Performance of Respective Examples

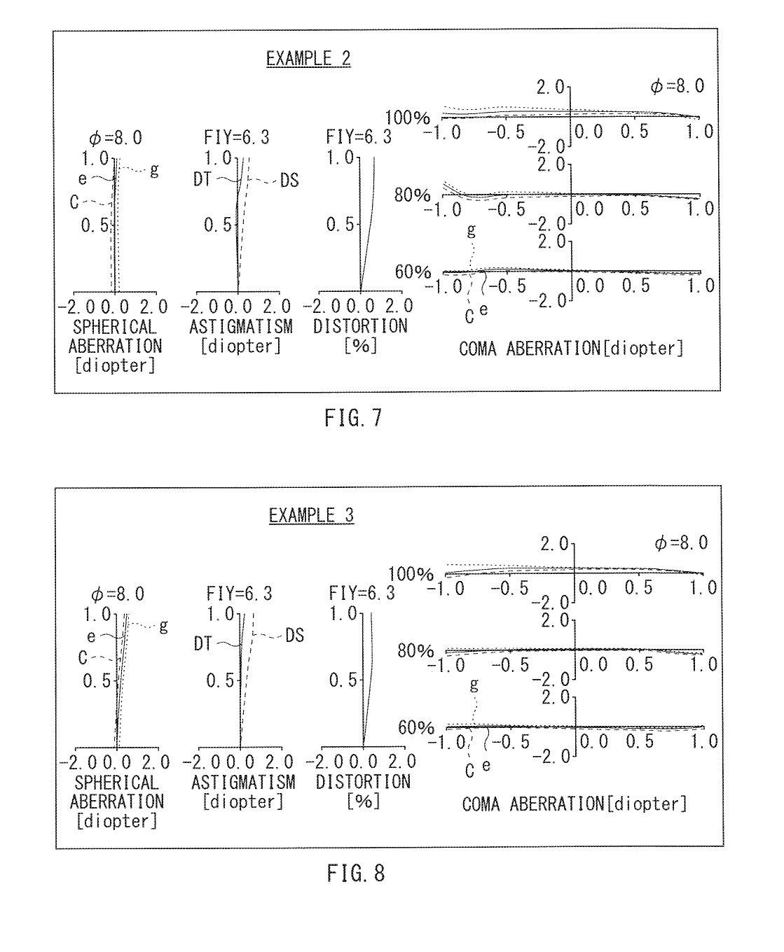

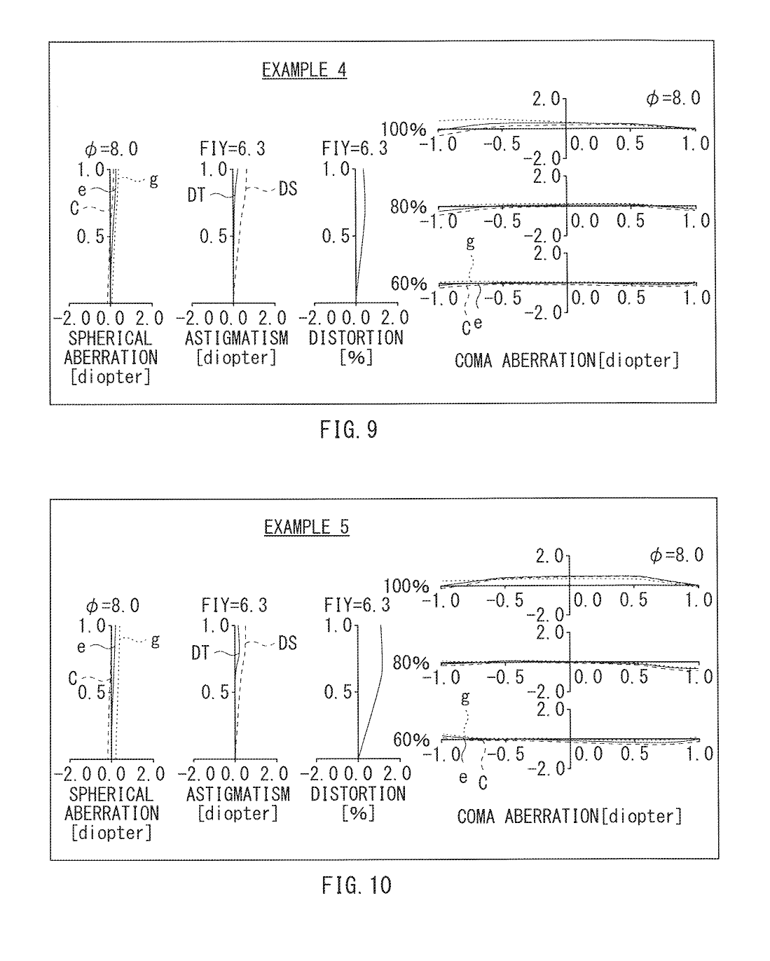

FIGS. 6 to 10 illustrate various aberrations where diopters of the eyepiece optical systems 1 to 5 according to Numerical examples 1 to 5, respectively, are −1 diopter.

In FIGS. 6 to 10, respective aberration diagrams illustrate, in order from the left, spherical aberration, astigmatism, distortion, and coma aberration. In the respective aberration diagrams, φ represents pupil diameter, and FIY represents a maximum image height in the display surface S1. In the spherical aberration diagram, a vertical axis shows a ratio thereof with respect to the pupil diameter φ. Further, a solid line represents spherical aberration for e-line (having a wavelength of 546 nm), and dashed lines represent spherical aberrations for C-line (having a wavelength of 656.3 nm) and for g-line (having a wavelength of 436 nm). In the astigmatism diagram, a vertical axis shows a ratio thereof with respect to the maximum image height FIY. Further, a solid line (DT) represents astigmatism in a tangential image plane, and a dashed line (DS) represents astigmatism in a sagittal image plane. In the distortion diagram, a vertical axis shows a ratio thereof with respect to the maximum image height FIY, and an amount of distortion is shown in %. In the coma aberration diagram, coma aberrations where the pupil diameters φ are 100%, 80%, and 60% are shown.

As can be clearly seen from the respective aberration diagrams, various aberrations are favorably corrected and superior optical performance is achieved in the eyepiece optical systems 1 to 5 according to Numerical examples 1 to 5.

### 5. Other Embodiments

The technology according to the present disclosure is not limited to the description of the embodiments and Examples above, and various modifications may be made.

For example, each of the shapes of the respective sections and the numerical values shown in the respective numerical examples above is a mere example for embodying the present technology, and the technical range of the present technology should not be limitedly construed on the basis thereof.

Moreover, in the embodiments and Examples above, description has been provided of the configuration substantially including four lenses. However, a configuration may be adopted in which a lens substantially has no refractive power is further provided.

It is possible to achieve at least the following configurations from the above-described example embodiments and the modifications of the disclosure.
[1] An eyepiece optical system including:

a first lens having a biconvex shape in optical axis center and having positive refractive power;

a second lens having negative refractive power;

a third lens having positive refractive power; and

a fourth lens having positive refractive power, the first to fourth lenses being arranged in order from an image to be observed, wherein

the following conditional expression is satisfied,

0.47<f3/f4<3.00 (1)

where f3 is a focal length of the third lens, and

f4 is a focal length of the fourth lens.
[2] The eyepiece optical system according to [1], wherein the following conditional expression is satisfied,

12.0<250/ft<20.0 (2)

where ft is a total focal length of the eyepiece optical system.
[3] The eyepiece optical system according to [1] or [2], wherein the following conditional expression is satisfied,

1.5<t3/c3<4.0 (3)

where t3 is a center thickness of the third lens, and

c3 is an edge thickness of the third lens.
[4] The eyepiece optical system according to any one of [1] to [3], wherein the following conditional expression is satisfied,

1.5<t4/c4<3.0 (4)

where t4 is a center thickness of the fourth lens, and

c4 is an edge thickness of the fourth lens.
[5] The eyepiece optical system according to any one of [1] to [4], wherein the following conditional expression is satisfied,

5.0<d1/d2<10.0 (5)

where d1 is a distance from image plane to be observed to an image-sided lens surface of the first lens, and

d2 is a distance from a lens surface on an opposite side of the first lens from the image plane side to an image-sided lens surface of the second lens.
[6] The eyepiece optical system according to any one of [1] to [5], wherein the eyepiece optical system is used for observing, in an enlarged manner, an image displayed on a display surface of an image display device.
[7] The eyepiece optical system according to any one of [1] to [6], further including a lens substantially having no refractive power.
[8] An electronic apparatus including:

an image display device; and

an eyepiece optical system configured to allow observation, in an enlarged manner, of an image displayed on the image display device,

the eyepiece optical system including

a first lens having a biconvex shape in optical axis center and having positive refractive power,

a second lens having negative refractive power,

a third lens having positive refractive power, and

a fourth lens having positive refractive power, the first to fourth lenses being arranged in order from an image to be observed, wherein

the following conditional expression is satisfied,

0.47<f3/f4<3.00 (1)

where f3 is a focal length of the third lens, and

f4 is a focal length of the fourth lens.
[9] The electronic apparatus according to [8], further including an imaging section, wherein the image display device is configured to display an image shot by the imaging section.
[10] The electronic apparatus according to [8] or [9], further including a lens substantially having no refractive power.

It should be understood by those skilled in the art that various modifications, combinations, sub-combinations, and alterations may occur depending on design requirements and other factors insofar as they are within the scope of the appended claims or the equivalents thereof.

What is claimed is:

1. An eyepiece optical system comprising:
a first lens having a biconvex shape in optical axis center and having positive refractive power;
a second lens having negative refractive power;
a third lens having positive refractive power; and
a fourth lens having positive refractive power, the first to fourth lenses being arranged in order from an image to be observed, wherein
the following conditional expression is satisfied,
0.47<f3/f4<3.00 (1)
where f3 is a focal length of the third lens, and
f4 is a focal length of the fourth lens.

2. The eyepiece optical system according to claim 1, wherein the following conditional expression is satisfied,
12.0<250/ft<20.0 (2)
where ft is a total focal length of the eyepiece optical system.

3. The eyepiece optical system according to claim 1, wherein the following conditional expression is satisfied,
1.5<t3/c3<4.0 (3)
where t3 is a center thickness of the third lens, and
c3 is an edge thickness of the third lens.

4. The eyepiece optical system according to claim 1, wherein the following conditional expression is satisfied,
1.5<t4/c4<3.0 (4)
where t4 is a center thickness of the fourth lens, and
c4 is an edge thickness of the fourth lens.

5. The eyepiece optical system according to claim 1, wherein the following conditional expression is satisfied,
5.0<d1/d2<10.0 (5)
where d1 is a distance from image plane to be observed to an image-sided lens surface of the first lens, and
d2 is a distance from a lens surface on an opposite side of the first lens from the image plane side to an image-sided lens surface of the second lens.

6. The eyepiece optical system according to claim 1, wherein the eyepiece optical system is used for observing, in an enlarged manner, an image displayed on a display surface of an image display device.

7. An electronic apparatus comprising:
an image display device; and
an eyepiece optical system configured to allow observation, in an enlarged manner, of an image displayed on the image display device,
the eyepiece optical system including
a first lens having a biconvex shape in optical axis center and having positive refractive power,
a second lens having negative refractive power,
a third lens having positive refractive power, and
a fourth lens having positive refractive power, the first to fourth lenses being arranged in order from an image to be observed, wherein
the following conditional expression is satisfied,
0.47<f3/f4<3.00 (1)
where f3 is a focal length of the third lens, and
f4 is a focal length of the fourth lens.

8. The electronic apparatus according to claim 7, further comprising an imaging section, wherein the image display device is configured to display an image shot by the imaging section.
